(19) United States
(12) Patent Application Publication
(10) Pub. No.: US 2016/0366327 A1
(43) Pub. Date: Dec. 15, 2016

(54) METHOD AND SYSTEM FOR DETERMINING WHETHER A LAW ENFORCEMENT INSTRUMENT HAS BEEN REMOVED AND CONCURRENTLY ACTIVATING A BODY CAMERA

(71) Applicant: COLLATERAL OPPORTUNITIES, LLC, Willmington, DE (US)

(72) Inventor: MICHAEL KUSENS, COOPER CITY, FL (US)

(21) Appl. No.: 15/153,952

(22) Filed: May 13, 2016

Related U.S. Application Data
(60) Provisional application No. 62/173,228, filed on Jun. 9, 2015.

(51) Int. Cl. H04N 5/232

(52) U.S. Cl. CPC H04N 5/23203

(57) ABSTRACT

A system and method that allows law enforcement agencies, security organizations, and other persons to monitor whether a weapon, flashlight, handcuffs, and/or other law enforcement instrument has been unholstered. Where an instrument unholstering event occurs, a signal is virtually simultaneously sent to a body camera to begin audio/video recording. The body camera is worn by the law enforcement or security officer. The system includes a monitoring system that makes a determination of whether the instrument was removed based on information it receives from one or more sensors that are integrated into a belt/holster worn by the officer. The sensors can be pressure sensitive, magnetic, light based, accelerometer based, orientation based or a combination of such.

This application claims the benefit of and priority to U.S. Provisional Patent Application Ser. No. 62/173,228, filed Jun. 9, 2015, which is incorporated by reference in its entirety for all purposes.

### 1. FIELD OF THE DISCLOSURE

The present disclosure relates generally to body cameras and mores specifically to body cameras used by law enforcement and security personnael.

### 2. BACKGROUND

Interest in body cameras on police officers have surged recently, sparked in large part by the police shooting death of Michael Brown in Ferguson, Mo. This shooting and the uncertainty surrounding the incident touched off riots and a national conversation about the role of police in American communities. High profile lawmakers from both major political parties called for widespread adoption of police body cameras, including President Barack Obama who proposed to provide law enforcement agencies with $75 million to purchase cameras to help improve police transparency.

While body cameras provide positive benefits in many instances, their widespread adoption raises privacy concerns. Law enforcement could have video surveillance of anyone out in public who happened to be near a police office for any reason. This may necessitate the editing of countless hours of video recordings to blue out and de-identify innocent bystanders or people inadvertently caught on camera. Furthermore, some police departments argue storing the voluminous amount of data from an always-on body camera is prohibitively expensive and time consuming. Some body camera manufacturers try to remedy this issue by providing an on/off switch or button for the police office to use. This button, when pressed, will cause a recording to begin and will cease recording once the button is pressed again. While this method does address some of the issues, it is still a manual process and must rely on an individual making the decision to record and acting upon it. In the heat of the battle, the police office might forget to initiate the recording or if the officer were to knowingly and willingly want to commit an offense they may also choose not to initiate a recording.

The disclosed embodiments are directed to the above problems.

### SUMMARY OF THE DISCLOSURE

A system and method are disclosed that allows law enforcement agencies, security organizations, and other persons to monitor whether a weapon, flashlight, handcuffs, and/or other law enforcement instrument (collectively referred to as “Instrument” or “Instruments”), has been unholstered, and if so simultaneously send a signal to a body camera to begin audio/video recording.

The system can include a monitoring system that makes a determination of whether the instrument was removed based on information it receives from one or more sensors that can be integrated into a belt/holster worn by the Security Person. The sensors can be pressure sensitive, magnetic, light based, accelerometer based, orientation based or a combination of such.

### Definitions

Non-limiting definitions that will be used in describing certain embodiments include:

| | |
|---|---|
| Body Camera | A video recording system, worn by a law enforcement officer, |
| | Security Officer, or other individual (collectively referred to as |
| | “Security Personnel” or “Security Person”), typically mounted on |
| | their shirt, hat, or other location giving a first person perspective. |
| | When active, the body camera takes an audio and/or video recording, |
| | which is designed to record interactions by the Security Person with |
| | the public, gather video evidence, and reduce violent incidents |
| | between citizens and Security Personnel. The body camera will have |
| | a data connection to store audio/video telemetry. This data may be |
| | stored locally, downloaded at a later time, and/or transmitted |
| | simultaneously to a remote storage/monitoring location so long as a |
| | data connection (TCP/IP or comparable technology) exists between |
| | the body camera and the remote storage/monitoring location. The |
| | body camera may also contain time shifting technology that will |
| | constantly buffer a configurable amount of video (i.e. 90 or 120 |
| | seconds) so that when a recording is created, the buffered video can be |
| | transmitted and/or stored along with the real-time video. |
| | The body camera may contain a wireless receiver to receive data from |
| | one or more wired or wireless transmitters to facilitate communication |
| | between the body camera and the integrated and/or holster sensors, |
| | described below. The method of transmission can include, but is not |
| | limited to, WiFi, Bluetooth, NFC and other long or short-range |
| | frequencies transmission techniques now known or later developed. |
| Law Enforcement | A specially programmed computer or electronic system which |
| Instrument Monitoring | monitors sensors, both holster and integrated, and sends start and stop |
| System | recording signals to the body cameras when programmed events are |
| | detected via wired or wireless connection. |
| Central Dispatch | The location designated by a law enforcement agency, security |
| | organization, or other organization responsible for receiving and |
| | transmitting messages to Security Personnel, tracking vehicles and |
| | personnel, and recording other important information. Central |
| | Dispatch may process the information received from one or more |
| | body cameras in an organized manner to an individual or group of |
| | individuals assigned to Security Personnel. Central Dispatch will |
| | preferably be located within the facility where the Security Personnel |
| | are deployed and/or monitored but can also be located at any location |
| | so long as a data connection (TCP/IP or comparable technology) |
| | exists between the Central Dispatch and Body Camera(s). |
| Data Storage | One or more storage media, one or more electronic databases, random |
| | access memory (RAM), read-only memory (ROM), flash memory, |
| | and/or other types of electronic memory. |
| Holster Sensor | Sensors installed where Instruments are stored on a Security |
| | Personnel's person. The sensor(s) can be integrated into the lock/latch |
| | for a holster or compartment where an Instrument is stored. For a non- |
| | limiting example, this may include contact closures that are closed |
| | when a Security Personnel's Instrument is stored in its holder, but the |
| | contact is broken when the Instrument is removed, such as a snap for a |
| | gun or Taser. Additional non-limiting examples include, but are not |
| | limited to, pressure or weight sensors which can detect when a |
| | Security Personnel's Instrument has been removed from its holder, |
| | such as, but not limited to, a pressure sensor located where handcuffs |
| | are stored on an officer as well as magnetic field sensors (Hall Effect |
| | or Reed type sensors) that can detect the presence or change in |
| | magnetic fields caused by metallic objects such as numerous Law |
| | Enforcement Instruments. There may be one or more sensors for each |
| | Instrument. Non-limiting examples of what is included in the |
| | definition of Instrument include an officer's gun, nightstick, |
| | handcuffs, flashlight, knife, Taser, pepper spray, and/or other weapon |
| | or device. |
| Integrated Sensor | One or more sensors installed in or attached to an Instrument. These |
| | integrated sensors may include orientation sensors, accelerometers, |
| | and/or other sensors designed to detect whether an Instrument has |
| | been deployed. The integrated sensor(s) can be integrated into or onto |
| | the Instruments themselves. For a non-limiting example, this may |
| | include placing an orientation sensor and/or an accelerometer on the |
| | handle of a gun, Taser, flashlight or nightstick. There may be one or |
| | more integrated sensors placed in or on each Instrument, which has |
| | been defined above. |
| Law Enforcement | An Instrument used by Security Personnel, which as noted above can |
| Instrument | include, without limitation, guns, Tasers, flashlights, nightsticks, Billy |
| | clubs, breathalyzers, handcuffs, pepper spray, etc. |
| Security Personnel or | A police officer, law enforcement officer, security officer, security |
| Security Person | guard, security or nightclub bouncer or any individual using one or |
| | more Law Enforcement Instruments. |
| Transmission | The broadcasting of electromagnetic waves, signals, radio waves, |
| | electrical signals, light signals, Bluetooth signals, and/or other long or |
| | short-range frequencies transmission techniques now known or later |
| | developed. |

### BRIEF DESCRIPTION OF THE DRAWINGS

FIG. 1 illustrates a combination block diagram and process flow for a security personnel instrument removal determination in accordance with one embodiment of the present disclosure;

FIG. 2 illustrates a combination block diagram and process flow for centralized monitoring and alerting in accordance with one embodiment of the present disclosure;

FIG. 3 illustrates the various components for practicing the process in accordance with one embodiment of the present disclosure;

FIG. 4 illustrates a combination block diagram and process flow for monitoring whether a Law Enforcement Instrument has been activated in accordance with one embodiment of the present disclosure; and

FIG. 5 illustrates the various components for practicing the process in accordance with another embodiment of the present disclosure.

### DETAILED DESCRIPTION

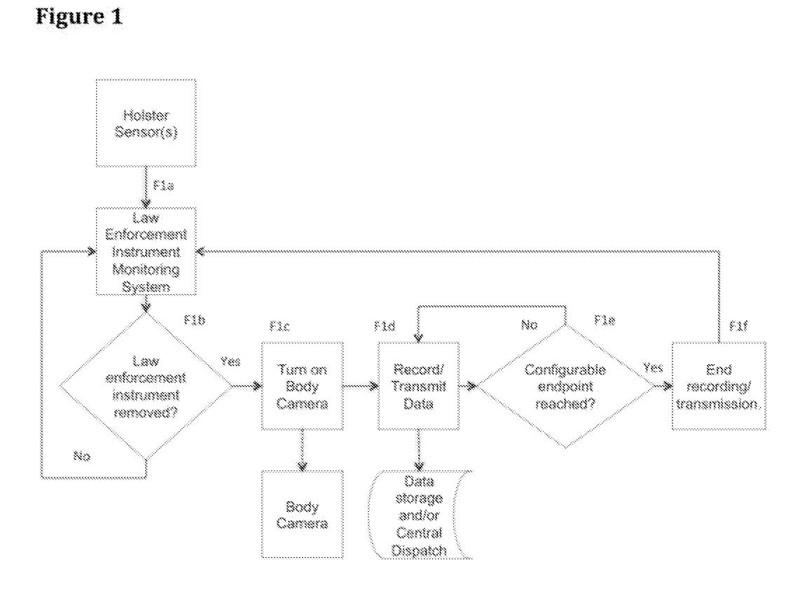

FIG. 1 shows the workflow for monitoring whether an Instrument has been removed from its holster or container, which under the described novel embodiment will concurrently activate a body camera being worn by the Security Person associated with the Instrument through the use of one or more pressure, weight, magnetic field and/or other sensors.

At F1a, one or more holster sensors can be installed where the Law Enforcement Instruments are stored on a Security Person's person. The sensor(s) can be integrated into the lock/latch for a holster, compartment, container, box, etc. (collectively referred to as “Holder”) or directly within the Holder where the Law Enforcement Instrument is stored. As a non-limiting example, this may include contact closures that are closed when the Law Enforcement Instrument is stored in its Holder, with the contact being broken when the Law Enforcement Instrument is removed, such as a snap for a gun or Taser. Additional non-limiting examples include pressure or weight sensors which can detect when the Law Enforcement Instrument has been removed from its Holder, such as a pressure sensor located where handcuffs are stored on an officer as well as magnetic field sensors which can detect the presence of metallic objects or magnetic fields. There can be one or more sensors for each Law Enforcement Instrument. The sensors are connected via wired or wireless connection to the Law Enforcement Instrument Monitoring System.

At F1b, the Law Enforcement Instrument Monitoring System monitors the one or more holster sensors and can be specifically configured or programmed to recognize the removal of a Law Enforcement Instrument using the breaking of a contact, the lessening or removal of a weight, the loss of contact, change in magnetic fields, etc. (depending on the type of sensor(s) deployed or incorporated within the Holder) If the system does not detect a Law Enforcement Instrument being removed, the system will continue to monitor the sensors.

At F1c, once the Law Enforcement Instrument Monitoring System detects that a Law Enforcement Instrument has been removed due to data received from one or more of the holster sensors, a signal is automatically sent to the body camera by the Law Enforcement Instrument Monitoring System to cause the body camera to automatically begin recording audio and/or visual data, without having to be operated or turned on by the Security Person.

Optional functionality or features for the system and within the scope of the disclosure can include the ability for the body camera to have capabilities (hardware and software) to allow it to identify the Security Person's specific location using GPS or similar location identification technology now developed or developed in the future, and sending that location information and the identification of which Law Enforcement Instrument was deployed to Central Dispatch such as through a wireless TCP/IP transmitter in the body camera or through the Security Person's cellular telephone, radio, or other communication tool utilized by the Security Person.

Time shifting technology that will constantly buffer a configurable amount of video (i.e. 90 or 120 seconds) so that when a recording is created, the buffered video can be transmitted and/or stored along with the real-time video is also an optional feature/function of the system and within the scope of the disclosure.

At F1d, audio and/or visual data from the body camera can be recorded on an internal storage media of the body camera and/or transmitted to a remote storage location or Central Dispatch. Recorded data and/or location/Instrument identification information may be sent from the body camera to the storage device through wires or Bluetooth or another long or short-range frequency transmission technology or by other preferably wireless transmission technology now known or later developed. In addition or in the alternative, audio/video telemetry may be transmitted to a remote storage location or Central Dispatch so long as a data connection (TCP/IP or comparable technology) exists between the body camera and the remote storage/monitoring location.

At f1e, the body camera may be configured to record based on the preferences of the department or administrator associated with the Security Person. As a non-limiting example, the body camera may record for a set length of time following the removal of a law enforcement instrument, indefinitely following the removal of a law enforcement instrument, for the time period until which the law enforcement instrument is returned to its holster, or based or configured in any number of ways. Recording can continue until one of the aforementioned configurable endpoints is reached or the body camera is manually turned off, such as by the Security Person. Additionally, recordings may contain video that was taken prior to the removal of a law enforcement instrument, which was buffered in the internal storage media of the camera based on the configured settings.

At F1f, if the configurable endpoint is reached, then the system sends a signal to the body camera to cease recording, and The Law Enforcement Instrument Monitoring System resumes monitoring the holster sensor(s).

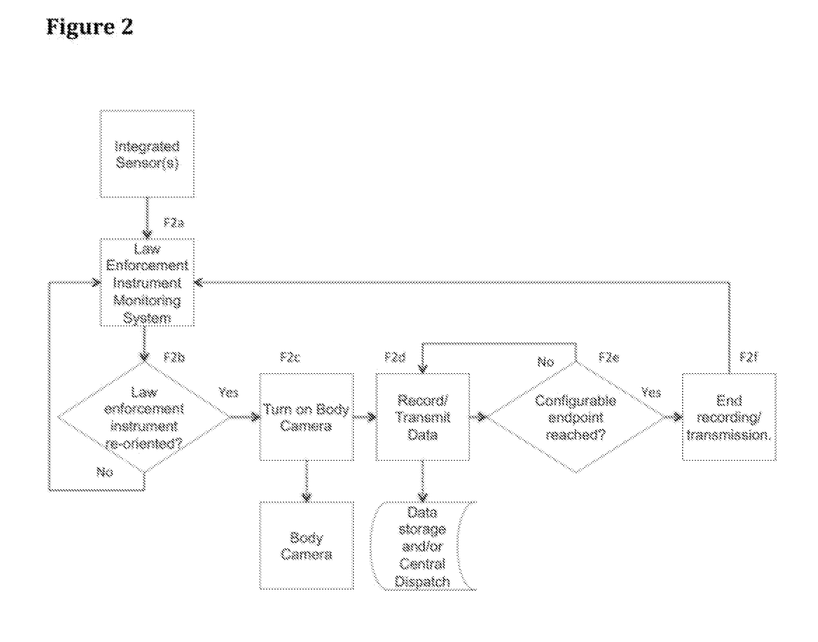

FIG. 2 shows the workflow for monitoring whether a Law Enforcement Instrument has been oriented in a manner consistent with use of that instrument, and concurrently automatically activating a body camera through the use of one or more orientation sensors, accelerometers, and/or other sensors.

At F2a, one or more integrated sensors can be installed on Law Enforcement Instruments. These integrated sensors may include orientation sensors, accelerometers, and/or other sensors designed to detect whether a Law Enforcement Instrument has been deployed. The integrated sensor(s) can be integrated into or onto the Law Enforcement Instruments themselves, in addition to or lieu of the sensors incorporated with the Holder described for FIG. 1. As a non-limiting example, this may include placing an orientation sensor and/or an accelerometer on the handle of a gun, Taser, or nightstick. Additionally, if the integrated sensor detects the instrument has been oriented in a manner consistent with that instruments use or has changed by a configurable value or percentage (which can be previously programmed), a signal can be transmitted by Bluetooth or another incorporated long or short-range frequency transmission technology or by other preferably wireless transmission technology now known or later developed to the Law Enforcement Instrument Monitoring System through a wireless transmitter also integrated with the sensors attached to the Law Enforcement Instrument. There may be one or more integrated sensors placed in or on each Law Enforcement Instrument. As a non-limiting example, integrated sensors may be placed in or on an officer's gun, nightstick, handcuffs, Taser, pepper spray, and/or other weapon or device.

At F2b, the Law Enforcement Instrument Monitoring System receives data from one or more integrated sensors and is configured to recognize the orientation of a Law Enforcement Instrument when it has been deployed. As a non-limiting example, a gun it its holster will be oriented differently from a gun drawn and pointed at a target. Optional functionality or features for the system and within the scope of the disclosure can include the ability for accelerometer readings and/or holster sensors as in FIG. 1, to be used to confirm orientation sensor readings that a Law Enforcement Instrument has been unholstered.

At F2c, once the Law Enforcement Instrument Monitoring System determines that a Law Enforcement Instrument has been oriented in a manner consistent with that Law Enforcement Instrument being used, a signal is automatically sent to the body camera by the Law Enforcement Instrument Monitoring System to begin recording audio and/or visual data. Optional functionality or features for the system and within the scope of the disclosure can include the ability for the body camera to identify the Security Person's specific location using GPS or similar location identification technology now developed or developed in the future, and sending that location information and the identification of which Law Enforcement Instrument was deployed to Central Dispatch through a wireless TCP/IP transmitter in the body camera or through the Security Person's cellular telephone, radio, or other communication tool utilized by the Security Person.

Time shifting technology that will constantly buffer a configurable amount of video (i.e. 90 or 120 seconds) so that when a recording is created, the buffered video can be transmitted and/or stored along with the real-time video is also an optional feature/function of the system and within the scope of the disclosure.

At F2d, audio and/or visual data from the body camera can be recorded on an internal storage media of the body camera and/or transmitted to a remote storage location or Central Dispatch. Recorded data and/or location/Instrument identification information may be sent from the body camera to the storage device through wires or Bluetooth or another long or short range frequency transmission technology or by other preferably wireless transmission technology now known or later developed. In addition or in the alternative, audio/video telemetry may be transmitted to a remote storage location or Central Dispatch so long as a data connection (TCP/IP or comparable technology) exists between the body camera and the remote storage/monitoring location.

At F2e, the body camera may be configured to record based on the preferences of the department or administrator associated with the Security Person. As a non-limiting example, the body camera may record for a set length of time following the removal or “in use” orientation of a law enforcement instrument, indefinitely following the removal or “in use” orientation of a law enforcement instrument, for the time period until which the law enforcement instrument is returned to its holster or original or “other non-use” orientation, or based or configured in any number of ways. Recording will continue until one of the aforementioned configurable endpoints is reached or the body camera is manually turned off, such as by the Security Person. Additionally, recordings may contain video that was taken prior to the removal of a law enforcement instrument, which was buffered in the internal storage media of the camera based on the configured settings.

At F2f, if the configurable endpoint is reached, then the system sends a signal to the body camera to cease recording, and The Law Enforcement Instrument Monitoring System resumes monitoring the integrated and/or holster sensor(s).

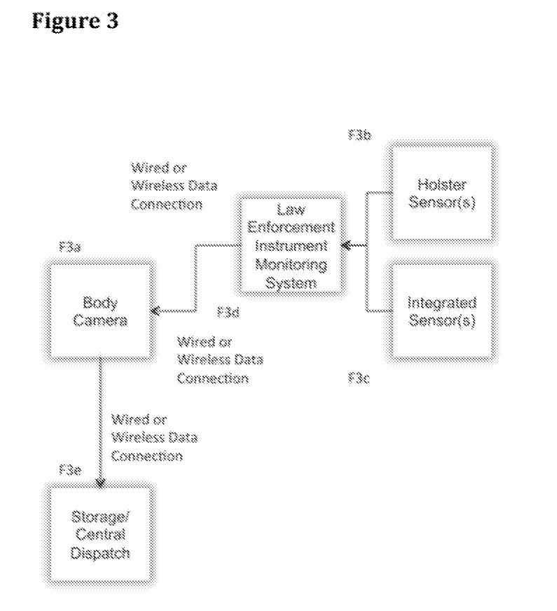

FIG. 3 illustrates one embodiment of the various components that can be used for practicing the above described method and how the components communicate with each other.

At F3a, the body camera is a video recording system worn by the Security Person. The body camera preferably comprises one or more cameras and/or microphones. When active, the body camera takes audio and/or video recordings of its field of view and can store it on internal storage media and/or transmits it to a remote storage location via any available wired or wireless technology.

At F3b, a holster sensor(s) can be a sensor or series of sensors designed to detect when a Law Enforcement Instrument has been taken out of its holster or holder. The sensor(s) can be integrated into the lock/latch for a holster or compartment/container/box where a Law Enforcement Instrument is stored and in one embodiment, can be based on a contact closure that is closed when a Law Enforcement Instrument is in its holder, but the contact is broken when the Law Enforcement Instrument is removed. Additional non-limiting examples include pressure sensors, weight sensors and/or magnetic field sensors (Hall Effect or Reed Switch), which can be used in the detection of when a Law Enforcement Instrument has been removed from its associated holder/holster. There may be one or more sensors for each Law Enforcement Instrument.

When the Law Enforcement Instrument Monitoring System detects, based on data received from one or more holster sensor(s), that a law enforcement instrument has been unholstered, a signal will be sent to the body camera from the Law Enforcement Instrument Monitoring System to automatically begin recording video and/or audio by the body camera without any manual operation or manual input from the Security Person. Thus, the Security Person does not have to manually or physically turn on the body camera, as his or her actions with the law enforcement instrument automatically cause the body camera to turn on or otherwise be activated. This signal can be transmitted through a wire or Bluetooth or another long or short-range frequency transmission technology or by other preferably wireless transmission technology now known or later developed. Time shifting technology that will constantly buffer a configurable amount of video (i.e. 90 or 120 seconds) so that when a recording is created, the buffered video can be transmitted and/or stored along with the real-time video is also an optional feature/function of the system and within the scope of the disclosure.

At F3c, an integrated sensor(s) can be a sensor or series of sensors designed to detect when a Law Enforcement Instrument has been drawn. The integrated sensor(s) may include, without limitation, an accelerometer and/or orientation sensor, and a Bluetooth or another long or short range frequency transmitter, or any other preferably wireless transmission technology now known or later developed. When the Law Enforcement Instrument Monitoring System detect that a law enforcement instrument has been unholstered based on data received from one or more integrated sensors, a signal will be sent to the body camera from the Law Enforcement Instrument Monitoring System to automatically begin recording video and/or audio by the body camera without any manual operation or manual input from the Security Person. This signal is transmitted through a wire or Bluetooth or another long or short-range frequency transmission technology or by other preferably wireless transmission technology now known or later developed. Time shifting technology that will constantly buffer a configurable amount of video (i.e. 90 or 120 seconds) so that when a recording is created, the buffered video can be transmitted and/or stored along with the real-time video is also an optional feature/function of the system and within the scope of the disclosure.

At F3d, the Law Enforcement Instrument Monitoring System is a specially programmed system which monitors information received from sensors, which can be holster sensors, integrated sensors or both, and sends start and stop recording signals to the body cameras when programmed events are detected via wired or wireless connection.

At F3e, when active or otherwise “on”, the body camera records, transmits, and/or stores audio and/or visual data. Data may be stored locally on a storage device internally as part of the body camera or attached to the body camera or located on the individual and in electrical communication with the body camera. Data may be sent from the body camera to the storage device through wires or Bluetooth or another long or short-range frequency transmission technology or by other preferably wireless transmission technology now known or later developed. In addition or in the alternative, audio/video telemetry may be transmitted to a remote storage location or Central Dispatch so long as a data connection (TCP/IP or comparable technology) exists between the body camera and the remote storage/monitoring location.

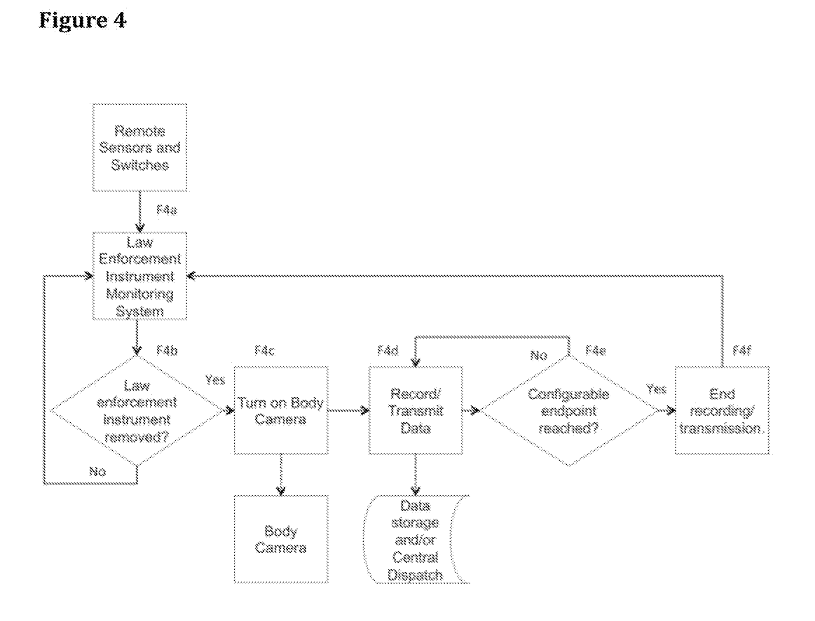

FIG. 4 shows the workflow for monitoring whether a Law Enforcement Instrument has been activated by the Security Person, which under the described novel embodiment will concurrently activate a body camera being worn by the Security Person associated with the Instruments through the use of one or more pressure, weight, magnetic field, sound, orientation, accelerometer, light, relay, circuit, contact and/or other sensors or switches.

At F4a, one or more integrated sensors or switches can be installed on Law Enforcement Instruments. These integrated sensors may include, without limitation, pressure, weight, magnetic field, sound, orientation, accelerometer, light, contact and/or other sensors or switches designed to detect whether a Law Enforcement Instrument has been deployed. The integrated sensor(s) can be integrated into or onto the Law Enforcement Instruments themselves. As a non-limiting example, this may include placing an orientation sensor on the siren-activating switch and/or wiring into the siren circuit. Additionally, if the integrated sensor detects the instrument has been oriented in a manner consistent with that instruments use or has changed by a configurable value or percentage, a signal can be transmitted by Bluetooth or another incorporated long or short-range frequency transmission technology or by other preferably wireless transmission technology now known or later developed to the Law Enforcement Instrument Monitoring System through a wireless transmitter also integrated with the sensors attached to the Law Enforcement Instrument. There may be one or more integrated sensors placed in or on each Law Enforcement Instrument. As a non-limiting example, integrated sensors may be placed in or on an officer's siren, seat belts, seats (front or rear) or connected to the on-board diagnostics of the officer's vehicle to detect changes in speed, acceleration and other on-board systems

At F4b, the Law Enforcement Instrument Monitoring System receives data from one or more integrated sensors or switches and is configured to recognize when a sensor or switch has been activated indicating a Law Enforcement Instrument has been deployed. As a non-limiting example, a police car siren in the off position maintains a specific angle or orientation. When the siren is activated, the position of the switch is changed to a new angle. Optional functionality or features for the system and within the scope of the disclosure can include the ability for accelerometer readings and/or holster sensors as in FIG. 1, to be used to confirm orientation sensor readings that a Law Enforcement Instrument has been engaged.

At F4c, once the Law Enforcement Instrument Monitoring System determines that a Law Enforcement Instrument has been activated in a manner consistent with that Law Enforcement Instrument being used, a signal is automatically sent to the body camera by the Law Enforcement Instrument Monitoring System to begin recording audio and/or visual data. Optional functionality or features for the system and within the scope of the disclosure can include the ability for the body camera to identify the Security Person's specific location using GPS or similar location identification technology now developed or developed in the future, and sending that location information and the identification of which Law Enforcement Instrument was deployed to Central Dispatch through a wireless TCP/IP transmitter in the body camera or through the Security Person's cellular telephone, radio, or other communication tool utilized by the Security Person.

Time shifting technology that will constantly buffer a configurable amount of video (i.e. 90 or 120 seconds) so that when a recording is created, the buffered video can be transmitted and/or stored along with the real-time video is also an optional feature/function of the system and within the scope of the disclosure.

At F4d, audio and/or visual data from the body camera is recorded on an internal storage media of the body camera and/or transmitted to a remote storage location or Central Dispatch. Recorded data and/or location/Instrument identification information may be sent from the body camera to the storage device through wires or Bluetooth or another long or short range frequency transmission technology or by other preferably wireless transmission technology now known or later developed. In addition or in the alternative, audio/video telemetry may be transmitted to a remote storage location or Central Dispatch so long as a data connection (TCP/IP or comparable technology) exists between the body camera and the remote storage/monitoring location.

At F4e, the body camera may be configured to record based on the preferences of the department or administrator associated with the Security Person. As a non-limiting example, the body camera may record for a set length of time following the removal of a law enforcement instrument, indefinitely following the removal of a law enforcement instrument, for the time period until which the law enforcement instrument is returned to its original orientation, position, state, or based or configured in any number of ways. Recording will continue until one of the aforementioned configurable endpoints is reached or the body camera is manually turned off, such as by the Security Person. Additionally, recordings may contain video that was taken prior to the activation of a law enforcement instrument, which was buffered in the internal storage media of the camera based on the configured settings.

At F4f, if the configurable endpoint is reached, then the system sends a signal to the body camera to cease recording, and The Law Enforcement Instrument Monitoring System resumes monitoring the integrated sensor(s) and/or switches.

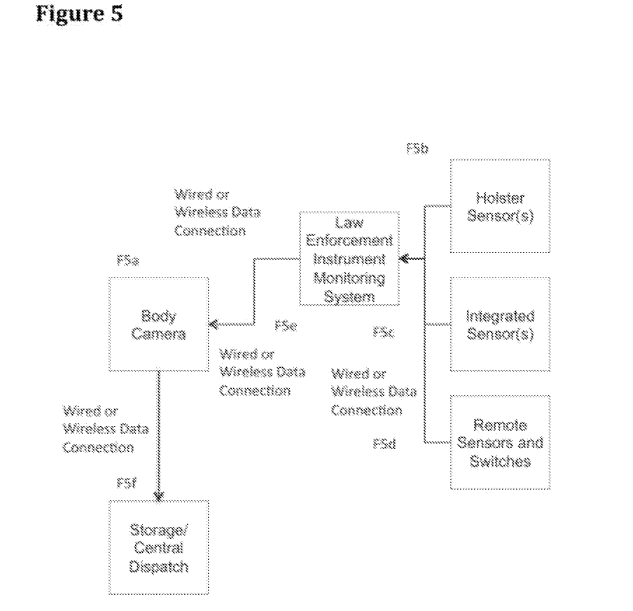

FIG. 5 illustrates another embodiment of the various components that can be used for practicing the above described method and how they communicate with each other.

At F5a, the body camera is a video recording system worn by the Security Person. The body camera consists of one or more cameras and/or microphones. When active, the body camera takes audio and/or video recordings of its field of view and stores it on internal storage media and/or transmits it to a remote storage location via any available wired or wireless technology.

At F5b, a holster sensor(s) can be a sensor or series of sensors designed to detect when a Law Enforcement Instrument has been taken out of its holster or holder. The sensor(s) can be integrated into the lock/latch for a holster or compartment/container/box where a Law Enforcement Instrument is stored and in one embodiment, can be based on a contact closure that is closed when a Law Enforcement Instrument is in its holder, but the contact is broken when the Law Enforcement Instrument is removed. Additional non-limiting examples include pressure sensors, weight sensors and/or magnetic field sensors (Hall Effect or Reed Switch), which can be used in the detection of when a Law Enforcement Instrument has been removed from its associated holder/holster. There may be one or more sensors for each Law Enforcement Instrument.

When the Law Enforcement Instrument Monitoring System detects, based on data received from one or more holster sensor(s), that a law enforcement instrument has been unholstered, a signal will be sent to the body camera from the Law Enforcement Instrument Monitoring System to automatically begin recording video and/or audio by the body camera without any manual operation or manual input from the Security Person. Thus, the Security Person does not have to manually or physically turn on the body camera, as his or her actions with the law enforcement instrument automatically cause the body camera to turn on or otherwise be activated. This signal is transmitted through a wire or Bluetooth or another long or short-range frequency transmission technology or by other preferably wireless transmission technology now known or later developed. Time shifting technology that will constantly buffer a configurable amount of video (i.e. 90 or 120 seconds) so that when a recording is created, the buffered video can be transmitted and/or stored along with the real-time video is also an optional feature/function of the system and within the scope of the disclosure.

At F5c, an integrated sensor(s) can be a sensor or series of sensors designed to detect when a Law Enforcement Instrument has been drawn. The integrated sensor(s) may include, without limitation, an accelerometer and/or orientation sensor, and a Bluetooth or another long or short range frequency transmitter, or any other preferably wireless transmission technology now known or later developed. When the Law Enforcement Instrument Monitoring System detect that a law enforcement instrument has been unholstered based on data received from one or more integrated sensors, a signal will be sent to the body camera from the Law Enforcement Instrument Monitoring System to automatically begin recording video and/or audio by the body camera without any manual operation or manual input from the Security Person. This signal is transmitted through a wire or Bluetooth or another long or short-range frequency transmission technology or by other preferably wireless transmission technology now known or later developed. Time shifting technology that will constantly buffer a configurable amount of video (i.e. 90 or 120 seconds) so that when a recording is created, the buffered video can be transmitted and/or stored along with the real-time video is also an optional feature/function of the system and within the scope of the disclosure.

At F5d, a remote sensor(s) and/or switch(s) can be a sensor or series of sensors or switches designed to detect when a Law Enforcement Instrument has been drawn. The remote sensor(s) and/or switch(s) may include, without limitation, pressure, weight, magnetic field, sound, orientation, accelerometer, light, relay, circuit, contact and/or other sensors or switches, and a Bluetooth or another long or short range frequency transmitter, or any other preferably wireless transmission technology now known or later developed. When the Law Enforcement Instrument Monitoring System detects that a law enforcement instrument has been activated based on data received from one or more remote sensor(s) and/or switch(s), a signal will be sent to the body camera from the Law Enforcement Instrument Monitoring System to automatically begin recording video and/or audio by the body camera without any manual operation or manual input from the Security Person. This signal is transmitted through a wire or Bluetooth or another long or short-range frequency transmission technology or by other preferably wireless transmission technology now known or later developed. Time shifting technology that will constantly buffer a configurable amount of video (i.e. 90 or 120 seconds) so that when a recording is created, the buffered video can be transmitted and/or stored along with the real-time video is also an optional feature/function of the system and within the scope of the disclosure.

At F1e, the Law Enforcement Instrument Monitoring System can be a specially programmed system which monitors sensors and switches; holster, remote and/or integrated; and sends start and stop recording signals to the body cameras when programmed events are detected via wired or wireless connection.

At F5f, when active, the body camera records, transmits, and/or stores audio and/or visual data. Data may be stored locally on a storage device internally as part of the body camera or attached to the body camera or located on the individual and in electrical communication with the body camera. Data may be sent from the body camera to the storage device through wires or Bluetooth or another long or short-range frequency transmission technology or by other preferably wireless transmission technology now known or later developed. In addition or in the alternative, audio/video telemetry may be transmitted to a remote storage location or Central Dispatch so long as a data connection (TCP/IP or comparable technology) exists between the body camera and the remote storage/monitoring location. Time shifting technology that will constantly buffer a configurable amount of video (i.e. 90 or 120 seconds) so that when a recording is created, the buffered video can be transmitted and/or stored along with the real-time video is also an optional feature/function of the system and within the scope of the disclosure.

Additional functionality within the scope of the embodiment but not necessary to its function includes the ability for the body camera to send an alert to Central Dispatch that a Law Enforcement Instrument has been drawn, which Law Enforcement Instrument was drawn, and/or GPS information of the officer's location. This transmission may occur through a connection with the officer's cellular telephone, or through a transmitter attached to the body camera and transmitted to Central Dispatch so long as a data connection (TCP/IP or comparable technology) exists between the body camera/cellular telephone and the Central Dispatch.

Time shifting technology that will constantly buffer a configurable amount of video (i.e. 90 or 120 seconds) so that when a recording is created, the buffered video can be transmitted and/or stored along with the real-time video is also an optional feature/function of the system and within the scope of the disclosure.

Additional functionality within the scope of the embodiment but not necessary to its function includes the ability for the body camera to send an alert to Central Dispatch that a Law Enforcement Instrument has been drawn, which Law Enforcement Instrument was drawn, and/or GPS information of the officer's location. This transmission may occur through a connection with the officer's cellular telephone, or through a transmitter attached to the body camera and transmitted to Central Dispatch so long as a data connection (TCP/IP or comparable technology) exists between the body camera/cellular telephone and the Central Dispatch.

The following non-limiting components can be preferably used for operation of the disclosed embodiments:
1. One or more holster and/or integrated Sensors and/or remote sensors/switches;
2. Body Camera in electronic communication with the Law Enforcement Instrument Monitoring System;
3. Law Enforcement Instrument Monitoring System in electronic communication with the one or more sensors, one or more body cameras and a centralized dispatch.

The various components can be in electrical, wired and/or wireless communication with each other.

Automatically determining whether a Law Enforcement Instrument has been removed and concurrently activating a body camera will provide significant administrative and safety benefits to Security Personnel and the general public alike, including, but not limited to, the following benefits and/or advantages:
1. Automation of activating body cameras on police interaction.
2. Reduction in violent confrontations between Security Persons and members of the public.
3. Reduction in privacy concerns associated with the use of body cameras.
4. Reduction in costs for litigation of cases involving actions taken by Security Personnel.
5. Increase in transparency in interactions between Security Personnel and the public.

The above described system and method can also work and communicate with a camera commonly mounted within a vehicle of the Security Personnel. Here the unholstering of the law enforcement instrument can also cause a signal to be sent to turn on the vehicle camera. The vehicle camera can be in addition to turning on a body camera as described above or can be in lieu of a body camera and both scenarios are also considered within the scope of the disclosure.

It should be understood that the exemplary embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from their spirit and scope.

All components of the described system and their locations, electronic communication methods between the system components, electronic storage mechanisms, sensor types, switch types, etc. discussed above or shown in the drawings, if any, are merely by way of example and are not considered limiting and other component(s) and their locations, electronic communication methods, electronic storage mechanisms, sensor types, switch types, etc. can be chosen and used and all are considered within the scope of the disclosure. It is also recognized that may of the processes and digital steps performed by the disclosed system and method may be achieved through server or cloud based technology.

Unless feature(s), part(s), component(s), characteristic(s) or function(s) described in the specification or shown in the drawings for a claim element, claim step or claim term specifically appear in the claim with the claim element, claim step or claim term, then the inventor does not consider such feature(s), part(s), component(s), characteristic(s) or function(s) to be included for the claim element, claim step or claim term in the claim when and if the claim element, claim step or claim term is interpreted or construed. Similarly, with respect to any “means for” elements in the claims, the inventor considers such language to require only the minimal amount of features, components, steps, or parts from the specification to achieve the function of the “means for” language and not all of the features, components, steps or parts describe in the specification that are related to the function of the “means for” language.

The benefits, advantages, solutions to problems, and any element(s) that may cause any benefit, advantage, or solution to occur or become more pronounced are not to be construed as a critical, required, or essential features or elements of any or all the claims.

While the disclosed embodiments have been described and disclosed in certain terms and has disclosed certain embodiments or modifications, persons skilled in the art who have acquainted themselves with the disclosure, will appreciate that it is not necessarily limited by such terms, nor to the specific embodiments and modification disclosed herein. Thus, a wide variety of alternatives, suggested by the teachings herein, can be practiced without departing from the spirit of the disclosure, and rights to such alternatives are particularly reserved and considered within the scope of the disclosure.

1. A system for automatically starting a camera upon the removal of a law enforcement instrument, comprising:
one or more holster sensor assemblies integrated into a lock or latch of a holster or a compartment used to store a law enforcement instrument;
one or more integrated sensor assemblies adapted for installation in or attachment to the law enforcement instrument;
a law enforcement instrument monitoring system in wireless communication with the one or more holster sensor assemblies and the one or more integrated sensor assemblies, said law enforcement instrument monitoring system programmed to receive first electronic data from the one or more holster sensor assemblies and second electronic data from the one or more integrated sensor assemblies when the law enforcement instrument is removed from the holster or compartment; and
circuitry or electronics incorporated into the camera in wireless communication with the law enforcement instrument monitoring system,
wherein based on the received first electronic data from the one or more holster sensors and the received second electronic data from the one or more integrated sensor assemblies where the law enforcement instrument monitoring system determines that the law enforcement instrument has been removed from the holster or compartment said law enforcement instrument monitoring system is programmed to send a wireless signal to the camera to cause the camera to automatically turn on and begin recording.

2. The system for automatically starting a camera upon the removal of a law enforcement instrument of claim 1 wherein the camera adapted to be worn by a security person who the law enforcement instrument is assigned to.

3. The system for automatically starting a camera upon the removal of a law enforcement instrument of claim 1 wherein the camera adapted to be mounted or secured within a motor vehicle assigned to a security person.

4. The system for automatically starting a camera of claim 1 wherein the one or more holster sensor assemblies are selected from a group comprising pressure sensitive, contact breaking sensing, magnetic, light based sensor assemblies and combinations thereof and the one or more integrated sensor assemblies are selected from a group comprising accelerometer based assemblies and orientation based assemblies and combinations thereof.

5. The system for automatically starting a camera of claim 1 further comprising an electronic storage database or memory in wireless communication with the camera for electronic receiving and electronically storing video recorded by the camera.

6. A system for automatically starting a body camera upon the removal of a law enforcement instrument, comprising:
one or more sensor assemblies integrated into a lock or latch of a holster or a compartment used to store a law enforcement instrument;
one or more integrated sensor assemblies adapted for installation in or attachment to the law enforcement instrument
a law enforcement instrument monitoring system in wireless communication with the one or more holster sensor assemblies and the one or more integrated sensor assemblies, said law enforcement instrument monitoring system programmed to receive first electronic data from the one or more holster sensor assemblies and second electronic data from the one or more integrated sensor assemblies and also programmed to determined when the law enforcement instrument is removed from the holster or compartment based on the received first electronic data and the received second electronic data; and
circuitry or electronics incorporated into a body camera in wireless communication with the law enforcement instrument monitoring system, the body camera adapted to be worn by a security person who the law enforcement instrument is assigned to;
wherein upon receipt of the electronic data from the one or more sensors indicating that the law enforcement instrument has been removed from the holster or compartment said law enforcement instrument monitoring system is programmed to send a wireless signal to the body camera to cause the body camera to automatically turn on and begin recording
wherein based on the received first electronic data from the one or more holster sensors and the received second electronic data from the one or more integrated sensor assemblies where the law enforcement instrument monitoring system determines that the law enforcement instrument has been removed from the holster or compartment said law enforcement instrument monitoring system is programmed to send a wireless signal to the camera to cause the camera to automatically turn on and begin recording without any physical action by the security person.

7. (canceled)

8. The system for automatically starting a body camera upon the removal of a law enforcement instrument of claim 6 wherein the law enforcement instrument monitoring system programmed to recognize a a range of positions for the law enforcement instrument to be considered to be “in use”; wherein based on the received second electronic data the law enforcement instrument monitoring system determines whether the law enforcement instrument is positioned within the range of position.

9. The system for automatically starting a body camera upon the removal of a law enforcement instrument of claim 8 further comprising a second camera adapted to be mounted or secured within a motor vehicle assigned to the security person; wherein when a signal is sent to the circuitry or electronics of the body camera by the law enforcement instrument monitoring system to turn on the body camera the law enforcement instrument monitoring system also sends a signal to circuitry or electronics of the second camera to automatically turn on the second camera.

10. The system for automatically starting a body camera of claim 6 further comprising an electronic storage database or memory in wireless communication with body camera for electronic receiving and electronically storing video recorded by the body camera.

11. The system for automatically starting a body camera of claim 9 further comprising an electronic storage database or memory in wireless communication with the body camera and the second camera for electronic receiving and electronically storing video recorded by the body camera and video recorded by the second camera.

12. The system for automatically starting a body camera of claim 6 further comprising location identification technology disposed within the body camera, wherein the location identifications technology configured to electronically send a current location information for the body camera to an electronic storage database or a central dispatch when the body camera is automatically activated from a signal received from the law enforcement instrument monitoring system when the law enforcement instrument monitoring system determines that the law enforcement instrument has been removed from the holster or compartment.

13. The system for automatically starting a body camera of claim 2 wherein the location identification technology also electronically sending information regarding ⁻which law enforcement instrument was removed to the electronic storage database or central dispatch.

14. A method for automatically starting a camera based on the removal of a law enforcement instrument assigned to a security person without any physical assistance by the security person, said method comprising the steps of:
a. receiving first electronic data from one or more holster sensor assemblies integrated into a lock or latch of a holster or a compartment used to store a law enforcement instrument or integrated into the law enforcement instrument itself by a law enforcement instrument monitoring system when the law enforcement instrument is removed from the holster or compartment;
b. receiving second electronic data from one or more integrated sensor assemblies installed or attached to the law enforcement instrument when the law enforcement instrument is within a preprogrammed range of positions representing an in use position for the law enforcement instrument; and
c. electronically sending a wireless signal to a camera being worn by a security person assigned to or associated with the law enforcement instrument or located within a vehicle assigned to a security person by the law enforcement instrument monitoring system to cause the camera to automatically begin recording when the law enforcement instrument monitoring system learns or determines that the law enforcement instrument has been removed from the holster or compartment and the law enforcement instrument is positioned within the range of “in use” positions.

15. The method for automatically starting a camera of claim 14 further comprising the step of electronically sending a second wireless signal to the camera to cause the camera to stop recording by the law enforcement instrument monitoring when a preprogrammed endpoint has been reached.

16. The method for automatically starting a camera of claim 14 further comprising the step of sending a second wireless signal to a second camera disposed within a vehicle associated with the security person concurrently with the signal being sent to the camera in step c by the law enforcement instrument monitoring system to cause the second camera to begin recording.

17. The method for automatically starting a camera of claim 14 further comprising the step of electronically sending the recording from the camera to an electronic storage database or a central dispatch.

18. The method for automatically starting a camera of claim 16 further comprising the step of electronically sending the recording from the camera and the recording from the second camera to an electronic storage database or a central dispatch.

19. The method for automatically starting a camera of claim 14 further comprising the step of identifying or determining a current location of the camera at the time the law enforcement instrument is removed from the holster or compartment and is positioned within the range of “in use” position based on location identification technology disposed within the camera.

20. The method for automatically starting a camera of claim 19 further comprising the step of electronically sending the current location information along with information regarding which law enforcement instrument was removed to a central dispatch or electronic storage database.

21. A method for automatically starting a camera based on the removal of a law enforcement instrument assigned to a security person without any physical assistance by the security person, said method comprising the steps of:
a. receiving first electronic data from one or more integrated sensor assemblies installed or attached to a law enforcement instrument by a law enforcement instrument monitoring system when the law enforcement instrument is removed from a holster or a storage compartment and the law enforcement instrument is within a preprogrammed range of positions representing an in use position for the law enforcement instrument; and
b. electronically sending a wireless signal to a camera being worn by a security person assigned to or associated with the law enforcement instrument or located within a vehicle assigned to a security person by the law enforcement instrument monitoring system to cause the camera to automatically begin recording when the law enforcement instrument monitoring system learns or determines that the law enforcement instrument has been removed from the holster or compartment and the law enforcement instrument is positioned within the range of “in use” positions.
